(19) United States
(12) Patent Application Publication
(10) Pub. No.: US 2010/0012432 A1
(43) Pub. Date: Jan. 21, 2010

(54) Collapsible Sawhorse

(76) Inventor: Larry M. NOEL, Flinton, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 12/175,149

(22) Filed: Jul. 17, 2008

(51) Int. Cl. F16M 11/00

(52) U.S. Cl. 182/153

(57) ABSTRACT

A collapsible sawhorse includes a center beam, a plurality of legs, a locking mechanism, and a bracket constructed in an offset or off-centered arrangement that allows the legs of the sawhorse to fold in an interlocking manner against the center beam. The sawhorse provides a user with a carpentry tool that is strong and may be easily transported, easily customized, and inexpensively manufactured.

### BACKGROUND OF THE INVENTION

1. Field of the Invention

The present invention relates generally to the field of carpentry tools, and more particularly, to sawhorse devices that are capable of collapsing or folding.

2. Description of Related Art

A sawhorse is a well-known support device used primarily by carpenters to cut wood and other raw materials used in the construction industry. The typical sawhorse consists of a center beam constructed of solid material that is attached to a support means, such as a plurality of legs. Carpenters typically require the use of a pair of sawhorses to cut construction materials. A sawhorse is positioned at each end of the material to be cut so as to hold the material in a position parallel to the ground. The carpenter then saws through the material at a point either in between the two sawhorses, or at one of the ends of the construction material. In addition to carpentry applications, sawhorses have been used for other tasks such as controlling vehicle traffic and crowds.

Known prior-art sawhorse devices include: U.S. Pat. No. 4,771,863; U.S. Pat. No. 4,771,319; U.S. Design Pat. No. 274,365; U.S. Pat. No. 4,245,718; U.S. Pat. No. 4,763,757; and U.S. Pat. No. 4,570,752.

A traditional problem with sawhorses has been their portability. To increase stability, sawhorses are typically constructed with legs that extend away at an angle from the median plane of the center beam. While this improves the stability of the sawhorse while the sawhorse is in use, the angled legs make the sawhorse unwieldy and difficult to transport. This can especially be a problem for professional carpenters who frequently travel to different job sites.

Attempts have been made to solve the portability problem. For example, U.S. Pat. No. 7,172,053 to Slavich discloses a portable sawhorse including extendable leg assemblies with a reinforcing mechanism between the legs. U.S. Pat. No. 5,813,495 to Smith discloses a collapsible sawhorse that includes hinged backing plates that connect the center beam to the legs and allow the legs to fold underneath the center beam. U.S. Pat. No. 6,564,903 to Krajec discloses a collapsible sawhorse bracket that allows the legs of the sawhorse to fold inwardly. U.S. Pat. No. 4,804,064 to Coultrup, et al, discloses an adjustable sawhorse which is collapsible in three transversely aligned directions.

The problems inherent in the aforementioned examples, as well as other prior art designed to address sawhorse portability, is their complexity and lack of strength. The lack of strength can stem from the connection point between the legs and center beam. For example, in the Krajec and Smith patents cited above, the legs connect to the center beam at points that are outside of the center beam's width. When a load is placed on top of a sawhorse, the force of the load pushes downward on the center beam. Since the point of connection of the sawhorse legs is outside of the center beam's width, the supporting force provided by the legs to counter the downward force of the load is not directly opposed to the downward force. Therefore, the legs' supporting force is not as great as it could be.

The lack of strength can also stem from the angle at which the legs attach to the center beam. For example, U.S. Pat. No. 5,813,495 to Smith and U.S. Pat. No. 6,564,903 to Krajec disclose collapsible sawhorses including legs that extend to a 90° angle relative to the transverse plane of the center beam when looking at the sawhorse from the side. This design subjects the sawhorse to the possibility of collapse when a force is applied to the center beam that causes the center beam to move laterally along the center beam's length. In addition, connecting the legs at a 90° angle relative to the horizontal plane of the center beam can make the sawhorse unstable when the sawhorse is erected on a non-level surface. For example, many job sites encountered by professional carpenters involve earth and stones that have not been graded flat. A sawhorse erected in such an environment is likely to slope downward in one direction due to the non-level character of the ground. If enough force is applied to the sawhorse in the direction of the downward slope, the sawhorse will collapse since the legs will not be adding supporting force in the opposite direction of the downward sloping force. For this reason, the legs' supporting force is not as great as it could be.

A further lack of strength associated with the prior art involves the means of connecting the center beam to the legs. U.S. Pat. No. 4,298,094 to Strong, U.S. Pat. No. 5,813,495 to Smith, U.S. Pat. No. 7,172,053 to Slavich, and U.S. Pat. No. 4,804,064 to Coultrup et al. all disclose collapsible sawhorses including a supporting mechanism that connects to the underside of the center beam. In other words, the center beam sits on top of the connecting mechanism with nothing holding the lateral sides of the center beam in place. This arrangement results in a lack of strength against a force that torques the center beam. For example, if a strong force is applied to a lateral edge of the center beam, the beam will torque towards the lateral edge since there is no supportive force being applied against the torque by the connecting means. If the torque is strong enough, the center beam will separate from the connecting means. Therefore, the strength of the connection between the center beam and the legs is not as great as it could be.

The bigger problem encountered with the prior-art examples is their complexity. For example, the Smith and Slavich patents referenced above consist of many moving parts such as hinges and telescoping legs. Moving parts are typically more likely to break than nonmoving parts. This is especially true in harsh environments such as construction sites where the sawhorse is exposed to inclement weather, non-level surfaces, and heavy objects that accidentally fall onto the sawhorse with some degree of frequency. Moreover, more complexity usually equals higher production costs. The number of different parts and the need to spend time assembling them result in higher costs to manufacture the finished sawhorse. Most manufacturers pass on such costs to their customers. In an industry as competitive as professional carpentry, expenses for tools and supplies can greatly affect a carpenter's income.

Accordingly, it is desirable to overcome the above problems and others by providing a sawhorse that is easily portable, strong, and capable of bearing heavy loads. There is also a need for a sawhorse capable of meeting the aforementioned needs that can be manufactured cheaply by using a minimal number of different parts. Furthermore, there is a need for a sawhorse that can be easily adjusted by the person using it.

### SUMMARY OF THE INVENTION

The present invention is directed to an apparatus that satisfies the aforementioned needs. The present invention is a sawhorse that is strong, fully collapsible, fully adjustable, and less expensive to manufacture than similar collapsing sawhorses in the prior art. The sawhorse includes a center beam that may be constructed using any solid material of any length and width. In one embodiment of the invention, the center beam is a standard 2 inch×6 inch wooden plank that the user may cut to his or her desired length. The legs of the sawhorse may also be constructed of any solid material of any length and width. A user may choose the length of the legs according to the sawhorse height he or she desires. In one embodiment of the invention, the legs are constructed out of standard 2 inch×4 inch wooden planks, which the user may cut to his or her desired length.

In addition to the center beam and legs, the present invention includes a bracket that connects the legs to the center beam. The bracket includes a top socket in which the center beam is attached to the bracket and a pair of leg sockets in which the legs of the sawhorse are inserted. The bracket is constructed in an “off-centered arrangement.” The “off-centered arrangement” of the bracket refers to the positioning of the leg sockets in relation to the median plane of the top socket. As used herein, the phrase “off-centered arrangement” means, in the case of an embodiment of the invention includes a pair of two legs, both the interior walls of the leg sockets are connected to the top socket at points that are to one side of the median plane of the top socket. For example, both the interior walls of the leg sockets may be connected to the top socket at points that are to the right of the top socket's median plane. This off-set or off-centered arrangement of the bracket is an important feature of the present invention because it allows the legs of the sawhorse to alternately fold against the center beam in a compact, interlocked way. In one embodiment, the brackets of the sawhorse are positioned a particular distance apart so that when the legs are folded against the center beam, the internal legs of the sawhorse fit neatly into the pocket created in the space between the interior walls of the leg sockets.

The “off-centered arrangement” of the bracket is also important to the present invention because it reduces the costs to manufacture the bracket. The bracket only needs to be manufactured in one “off-centered” direction to construct a complete sawhorse (e.g., a manufacturer only needs to make a bracket that is to the left of center to construct the present invention—it is not necessary to also manufacturer one that is right of center). When the “off-centered” bracket's orientation is reversed along a horizontal plane, the effect is a non-mirrored image of the bracket. This allows the legs to fold up in an alternating, interlocking manner.

In addition, the shape of the bracket strengthens the sawhorse because it places the tops of the legs directly underneath and within the width of the sawhorse's center beam. This puts the supporting forces supplied by the legs completely underneath the center beam and in a direction that is entirely opposite to the downward forces applied by the load sitting on the center beam. This orientation of the legs in relation to the center beam further strengthens the sawhorse and allows it to secure heavier loads than would be possible with a different design, such as the designs disclosed in the Krajec and Smith patents cited above.

The bracket of the present invention also strengthens the center beam against torque. In one embodiment, the center beam is connected to the bracket by drilling screws through the lateral edges of the top socket and into the lateral sides of the center beam. The connection on the lateral sides of the center beam provides a support force against any torque the center beam may experience.

In one embodiment of the present invention, the legs of the sawhorse are attached to the bracket in a “double-angle” manner when the legs are in the “open” position. The “double-angle” manner of the legs in this embodiment of the present invention is illustrated in U.S. Pat. No. 4,804,064 to Coultrup, et al., and U.S. Pat. No. 4,298,094 to Strong. The term “double-angle” means that the legs both extend beyond a 90° angle relative to the horizontal direction of the center beam and spread apart at a particular angle relative to the vertical direction of the center beam. The “double-angle” of the sawhorse legs provides further strength and stability to the sawhorse of the present invention.

In addition to the advantages described above, the present invention has only two moving parts. The first is the legs which are connected to the bracket. The legs are connected to the bracket in such a way as to allow the legs to pivot from a position parallel to the center beam to a fully-extended position. It also allows the legs to pivot fully into and out of the leg sockets thereby allowing the legs to fold narrowly against the center beam. In one embodiment of the present invention, the legs are connected to the bracket at an angle which makes the legs bind slightly together when the legs are folded into the “closed” position. If a leg would happen to break, all a user needs to do is to remove the bolt that attaches the broken leg to the bracket, remove the broken leg from its leg socket, insert a new leg into the leg socket, and bolt the new leg into the bracket.

The second moving part is a locking mechanism that holds the legs in their “open” position. In one embodiment of the invention, a rotating latch is attached to the leg of the sawhorse with a simple bolt or screw that allows the latch to rotate. In an alternative embodiment, the rotating latch also locks the legs when they are in their “closed” position.

Some advantages of the present invention are its portability, its strength compared to sawhorses in the prior art, the absence of many moving parts making the present invention more durable than the collapsible sawhorses in the art, and its simplicity which makes the present invention cheaper to manufacture. Still other desirable features of the invention will become apparent to those of ordinary skill in the art upon reading and understanding the following detailed description, taken with the accompanying drawings, wherein like reference numerals represent like elements throughout.

### BRIEF DESCRIPTION OF THE DRAWINGS

FIG. 1 is a perspective view of a sawhorse according to the present invention showing the bracket and the legs in an “open” position;

FIG. 2 is a rear side view of a sawhorse bracket according to the present invention showing the “off-centered arrangement” of the leg sockets in relation to the bracket's top socket;

FIG. 3 is a perspective view of a sawhorse according to the present invention showing the bracket and the legs in the “open” position;

FIG. 4 is a bottom side view of a sawhorse according to the present invention showing the bracket and the legs in the “open” position;

FIG. 5 is a bottom side view of a sawhorse according to the present invention showing the bracket and the legs in a “closed” position;

FIG. 6 is a perspective view of a sawhorse according to the present invention showing the bracket, locking mechanism, and the legs in the “open” position;

FIG. 7 is a front side view of a locking mechanism according to an embodiment of the present invention;

FIG. 8 is a perspective view of a sawhorse according to the present invention showing the bracket, locking mechanism, and the legs in the “open” position; and

FIG. 9 is a perspective view of a sawhorse according to the present invention showing the bracket, locking mechanism, and the legs in the “closed” position.

### DETAILED DESCRIPTION OF THE INVENTION

The present invention will now be described with reference to the accompanying figures. For purposes of the description hereinafter, the terms “right”, “left”, “top”, “bottom” and derivatives thereof shall relate to the invention as it is oriented in the drawing figures. However, it is to be understood that the invention may assume various alternative variations and step sequences, except where expressly specified to the contrary. It is to be understood that the specific apparatus illustrated in the attached figures and described in the following specification is simply an exemplary embodiment of the present invention. Hence, specific dimensions and other physical characteristics related to the embodiments disclosed herein are not to be considered as limiting.

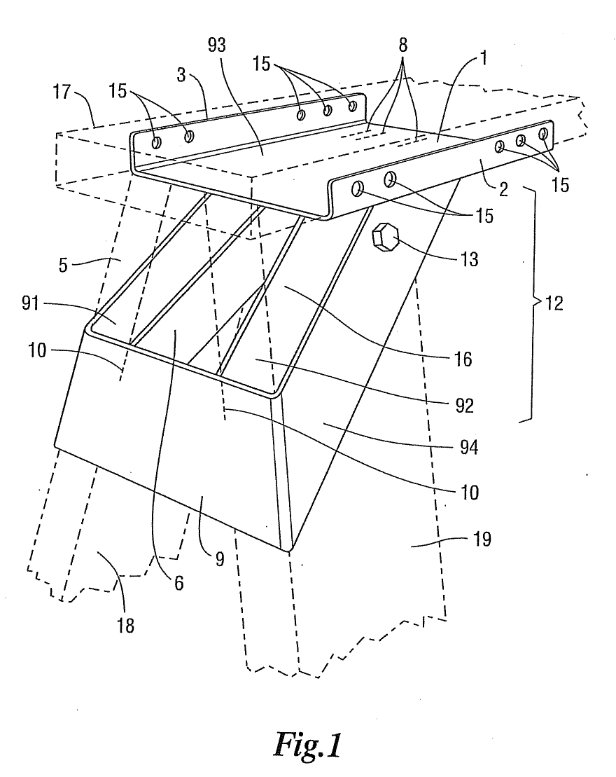

FIG. 1 depicts a sawhorse including a bracket 12, a center beam 17, and legs 18, 19. The bracket 12 includes a top socket 1, a stabilizer 9, and two leg sockets 91, 92. Each component of the bracket 12 may be constructed of a metal alloy such as steel, but any solid material may be used. It is also to be understood that the bracket 12 may be constructed of material having varying lengths, widths, and thicknesses. The bracket 12 depicted in FIG. 1 is an exemplary embodiment of utilizing a minimal amount of material with concern for increased material costs while maintaining the necessary structural stability to support the sawhorse. In any case, it is to be understood that other suitable dimensions may be more appropriate based upon the construction material of the bracket 12 and the application of use for the sawhorse. A first edge 2 and a second edge 3 of the top socket 1 are turned 90° in a direction perpendicular to the plane of the bottom plate 93 of the top socket 1 and in a direction opposite the two leg sockets 91, 92 of the bracket 12. Interspersed along the first edge 2 and the second edge 3 are holes 15. In one embodiment, there are a total of five holes 15 in each of the first edge 2 and the second edge 3, with three holes 15 positioned towards the front of the edges 2, 3, as is shown in FIG. 1.

Attached to the bottom plate 93 of the top socket 1 are the first leg socket 91 and the second leg socket 92. The first leg socket 91 includes an inside wall 16 and an outside wall 94. The inside wall 16 and the outside wall 94 may be welded 8 to the underside of the bottom plate 93, but any permanent method of attachment may be used. The second leg socket 92 includes an inside wall 6 and an outside wall 5. The inside wall 6 and the outside wall 5 may be welded 8 to the underside of the bottom plate 93, but any permanent method of attachment may be used.

A stabilizer 9 is permanently attached to each wall 16, 94, 6, 5 of the two leg sockets 91, 92. The stabilizer 9 may be welded 10 to the edge of the inner walls 16, 6 of the leg sockets 91, 92, but any permanent method of attachment may be used. The stabilizer 9 is designed to maintain the width of the leg sockets 91, 92 and hold the legs 18, 19 in their “open” position.

The center beam 17 is constructed of a solid material such as wood and may have a width that is equal to the interior width of the top socket 1. In one embodiment, the center beam 17 is attached to the bracket 12 by inserting the width of the center beam 17 into the top socket 1 as is shown in FIG. 1. Suitable fasteners, such as screws, are then inserted through the holes 15 in the first and second edge 2, 3 and are attached to the lateral sides of the center beam 17. In one embodiment, ten #10 2½ inch hardened screws are used to connect the center beam 17 to the top socket 1. While the use of screws provides a strong connection between the center beam 17 and the bracket 12, any permanent method of attachment may be used.

The legs 18, 19 of the sawhorse are connected to the bracket 12 by inserting the legs 18, 19 into the leg sockets 91, 92 and connecting the legs thereto by using a connecting mechanism 13 that allows the legs 18, 19 to pivot when inserted into the leg sockets 91, 92. In one embodiment, a 2¼ inch 5/16 bolt with a standard 5/16 lock nut is used as the connecting mechanism 13, but any connecting mechanism 13 that allows the legs 18, 19 to pivot consistent with the present invention may be used. The connecting mechanism 13 allows the legs 18, 19 to pivot from a “closed” position where the legs 18, 19 are parallel to the center beam 17 to an “open” position where the legs 18, 19 abut the stabilizer 9. FIG. 1 illustrates the legs 18, 19 in their “open” position. It is to be understood that the connecting mechanism 13, such as the bolt, may be oriented at an angle greater or less than 90° with respect to the inside and outside wall 16, 94 of the leg sockets 91, 92 in order to exert tension against the bracket 12 to reduce wobbling and increase stability of the legs 18, 19 of the sawhorse. Additionally, this angled orientation of the bolt causes the legs 18, 19 to bind against each other when in the “closed” position. For example, the orientation of the bolt may be inwardly and downwardly for improved binding of the legs 18, 19.

As is shown in FIG. 1, when the legs 18, 19 are extended into the “open” position, the legs 18, 19 may be oriented at opposing angles of approximately 15° relative to a vertical line running parallel to the median plane of the top socket 1 of the bracket 12. In addition to the 15° angles relative to the direction of the median plane, the legs 18, 19 may also be oriented at parallel angles of approximately 15° relative to a vertical line running parallel to the coronal plane of the top socket 1 of the bracket 12. Other suitable angles or angle ranges, such as from 10° to 20° may also be utilized. As used herein, the term “median plane” means the plane that runs through the top socket 1 of the bracket 12 from the top of bracket 12 to the bottom of the bracket 12, and divides the top socket 1 of the bracket 12 into left and right halves. As used herein, the term “coronal plane” means the plane that runs through the top socket 1 of the bracket 12 from the top of bracket 12 to the bottom of the bracket 12, and divides the top socket 1 of the bracket 12 into front and rear halves.

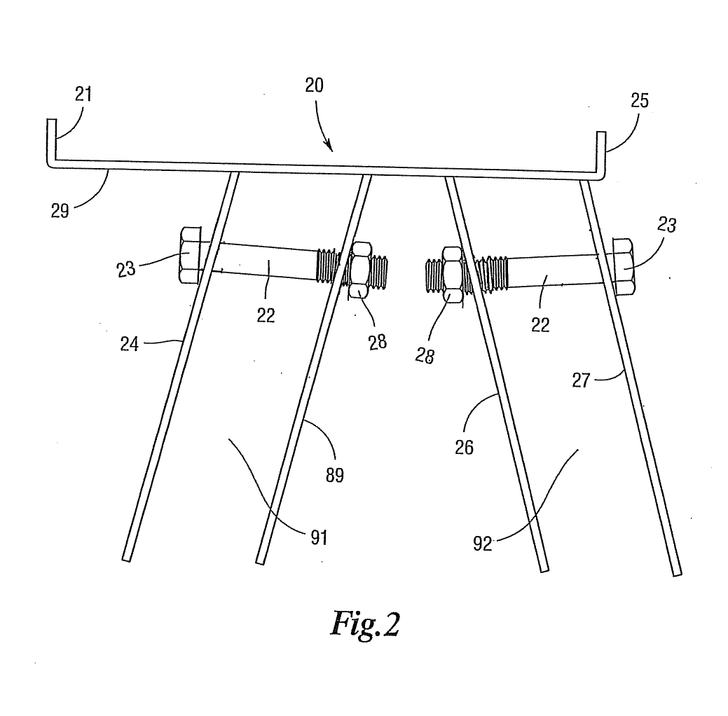

Referring to FIG. 2, the leg sockets 91, 92 are connected to the bottom plate 29 of the top socket 20 in an “off-centered arrangement” relative to the top socket's 20 vertical axis of symmetry. In one embodiment, the outside wall 27 of the first leg socket 92 is connected to the bottom plate 29 at a point that is about ⅛ of an inch inside the first edge 25 of the top socket 20, and the inside wall 89 of the second leg socket 91 is connected to the bottom plate 29 at a point that is about 2⅝ inches away from the second edge 21 of the top socket 20. In one embodiment, the distance between the weld point of the inside wall 26 of the first leg socket 92 and the weld point of the inside wall 89 of the second leg socket 91 is ⅝ of an inch, although any distance may be used. In one embodiment, the inner and outer walls 27, 26, 89, 24 of the leg sockets 91, 92 are welded to the bottom plate 29 at 15° angles relative to a vertical line running parallel to the median plane of the top socket 20, but the inner and outer walls 27, 26, 89, 24 may be connected to the bottom plate 29 at any angle. The legs are connected to the leg sockets 91, 92 by the connecting mechanism 23 which allows the legs to pivot inside the leg sockets 91, 92. In one embodiment, a 2¼ inch 5/16 bolt 22 with a standard 5/16 lock nut 28 is used as the connecting mechanism 23.

In one embodiment of the invention illustrated in FIG. 2, the connecting mechanism 23 is connected to the leg sockets 91, 92 in such a way as to cause the connecting mechanism 23 to slope in a downward direction from a point in the outer walls 24, 27 of the leg sockets 91, 92 to a point in the in the inner walls 89, 26 of the leg sockets 91, 92. This arrangement for the connecting mechanism 23 allows the legs of the sawhorse to more easily extend outward at the angles of the leg sockets 91, 92 when the legs are in the “open” position. The arrangement for the connecting mechanism 23 also allows the legs to fold underneath the width of the center beam and parallel with center beam's length. In addition, the illustrated arrangement for the connecting mechanism 23 causes the legs of the sawhorse to bind against each other when the legs are folded into the “closed” position.

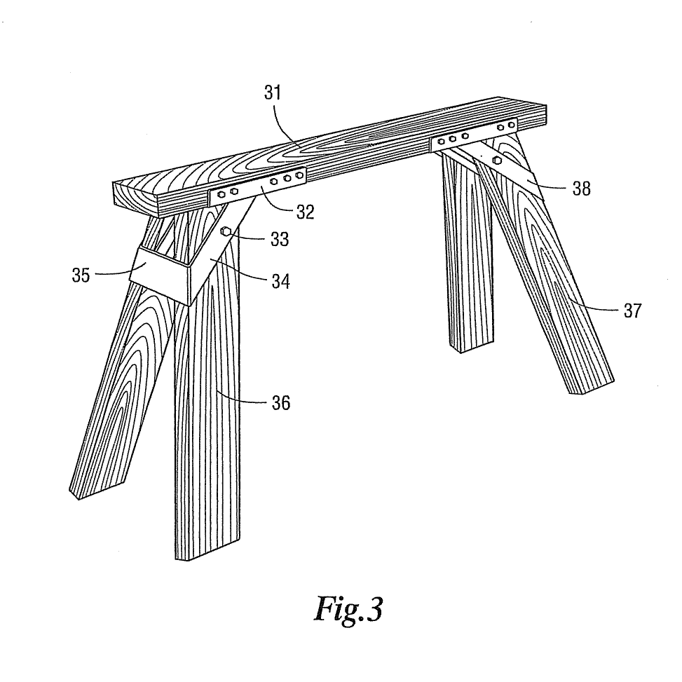

Referring to FIG. 3, the center beam 31 is connected to two opposing brackets 34, 38, and the brackets 34, 38 are connected to the legs 36, 37 of the sawhorse. FIG. 3 illustrates the legs 36, 37 in their “open” position. In the “open” position, the legs 36, 37 abut the stabilizer 35 that is part of the bracket 34. The center beam 31 is attached to the top socket 32 of the bracket 34 with ten #10 2½ inch hardened screws as shown in FIG. 3. The legs 36, 37 are connected to the leg sockets of the opposing brackets 34, 38 by the connecting mechanism 33 which allows the legs 36, 37 to pivot inside the leg sockets. In one embodiment, a 2¼ inch 5/16 bolt with a standard 5/16 lock nut is used as the connecting mechanism 33.

As is shown in FIG. 3, when the legs 36, 37 are extended into the “open” position, each leg 36, 37 may be oriented at an angle of approximately 15° relative to a vertical line running parallel to the median plane of the top socket 32 of the bracket 34. In addition to the 15° angle relative to the direction of the median plane, each leg 36, 37 may also be oriented at an angle of approximately 15° relative to a vertical line running parallel to the coronal plane of the top socket 32 of the bracket 34.

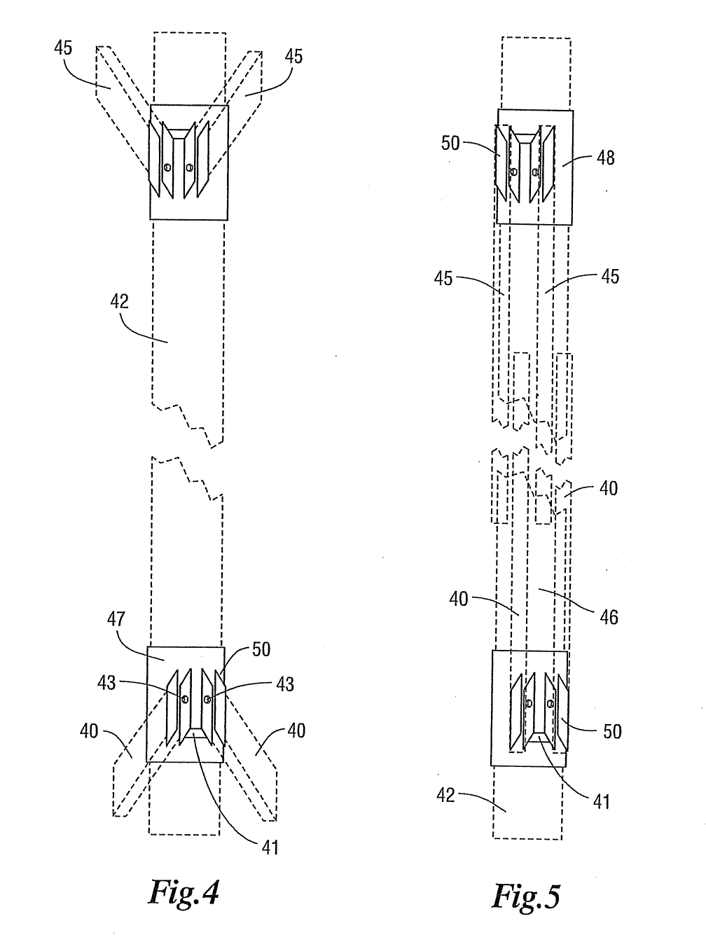

FIG. 4 illustrates the legs 40, 45 in the “open” position. The legs 40, 45 pivot about the axis of the connecting mechanism 43. In the “open” position, the legs 40, 45 pivots away from the center beam 42 and abut the stabilizer 41. FIG. 5 illustrates the legs 40, 45 in the “closed” position. In the “closed” position, the legs 40, 45 pivot away from the stabilizer 41 and abut the center beam 42. In the “closed” position, the legs 40, 45 are parallel with the horizontal plane of the center beam 42. As shown in FIG. 4 and FIG. 5, the “off-centered” position of the leg sockets 50 on the first bracket 47 and the second bracket 48 allows the legs 40, 45 to interlock when in the “closed” position. The interlocking of the legs 40, 45 allow the legs 40, 45 to lie flat when abutting the center beam 42.

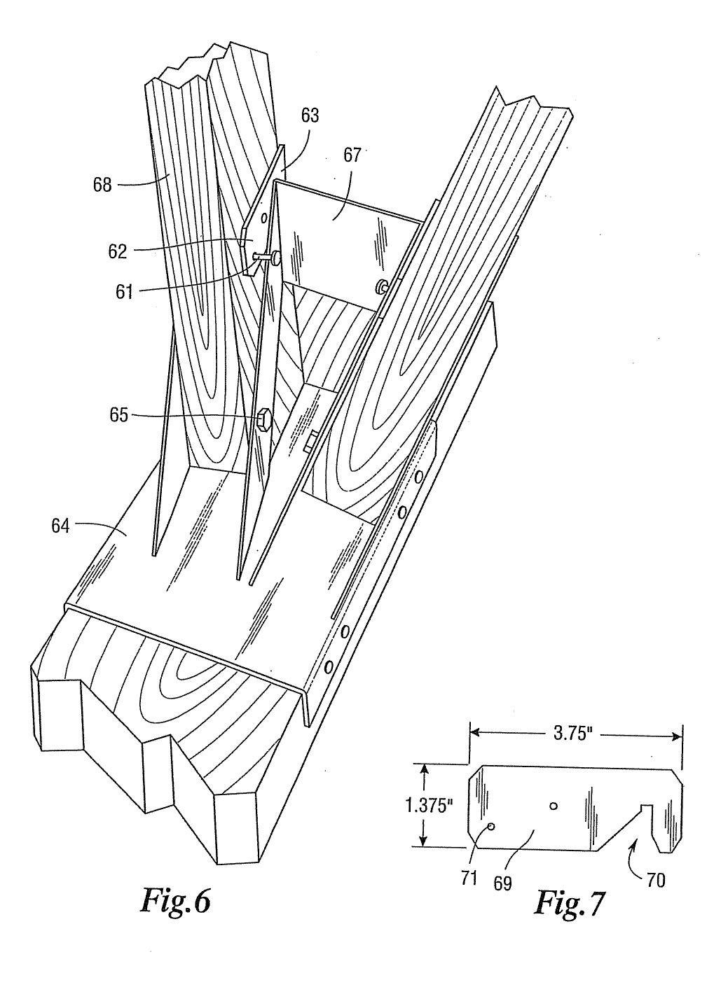

In the embodiment of the sawhorse shown in FIG. 6 and FIG. 7, a locking mechanism 62 is used to hold the sawhorse leg 68 in the “open” position. The locking mechanism 62 illustrated in FIG. 6 and FIG. 7 includes a pin 61 and a standard clip 69. The pin 61 allows the clip 69 to pivot at a pivot point 71 located at one lateral end of the clip 69. In one embodiment shown in FIG. 6 and FIG. 7, the pin 61 includes a standard nail and the clip includes a metal 3.75 inch by 1.375 inch lift-latch clip 69. When the leg 68 is pivoted about the connecting mechanism 65 to a position where the leg 68 abuts the stabilizer 67, the distal end 63 of the clip 69 is raised above the stabilizer 67, and then lowered onto the stabilizer 67 so that the stabilizer 67 slides into the groove 70 of the clip 69 thereby locking the leg 68 to the stabilizer 67.

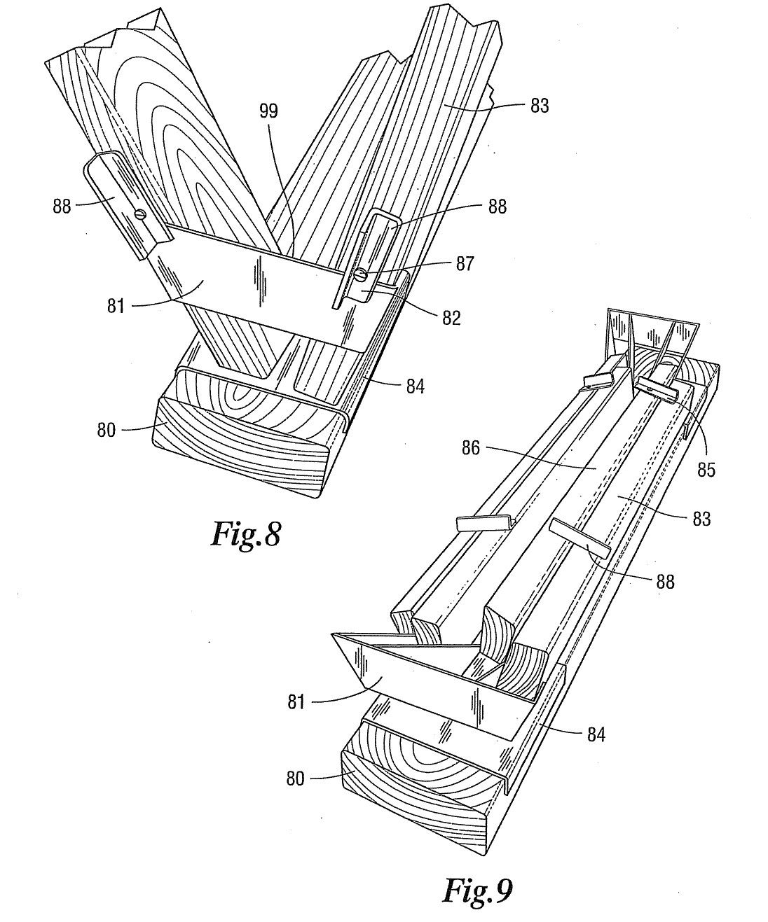

An alternative embodiment of the locking mechanism is shown in FIG. 8 and FIG. 9. FIG. 8 illustrates a locking mechanism 88 holding the leg 83 of the sawhorse in the “open” position. FIG. 9 illustrates the same locking mechanism 88 shown in FIG. 8 holding the legs 83, 86 of the sawhorse in the “closed” position. In the illustrated embodiments, the locking mechanism 88 includes a metal plane 82 folded 90° along its vertical axis. The metal plane 82 is attached to the leg 83 with a metal screw 87. The metal screw 87 is positioned just above the point where the leg 83 abuts the bottom edge 99 of the stabilizer 81. The metal screw 87 is tightened against the metal plane 82 to an extent that allows the metal plane 82 to rotate around the screw 87 with some amount of friction.

When the leg 83 is in its “open” position as shown in FIG. 8, the user rotates the locking mechanism 88 90° to release the leg 83 from the stabilizer 81. The user then pivots the leg 83 toward the center beam 80. When the leg 83 abuts the center beam 80, the user rotates the locking mechanism 88 into a direction parallel with the leg's 83 length and lowers the opposite leg 86 onto the center beam as illustrated in FIG. 9. When the opposite leg 86 abuts the center beam 80, the user rotates the locking mechanism 88 into a direction perpendicular to the leg's 83 length. When the user rotates the locking mechanism 85 90° on the opposite leg 86, both legs 83, 86 are locked in the “closed” position.

In one embodiment of the invention shown in FIG. 9, the opposing brackets of the sawhorse are spaced at a particular distance along the center beam 80 to allow the internal leg 86 to sit inside the space between the leg sockets of the bracket 84. This keeps the internal leg 86 from abutting the center beam 80 when the leg 86 is folded into the “closed” position. By not abutting the center beam 80, the internal leg 86 presses up against the locking mechanism 88, thereby creating a tighter lock than is otherwise possible.

The invention has been described with reference to the desirable embodiments. Modifications and alterations will occur to others upon reading and understanding the preceding detailed description. It is intended that the invention be construed as including all such modifications and alterations insofar as they come within the scope of the appended claims or the equivalents thereof.

The invention claimed is:

1. A collapsible sawhorse comprising:
(a) a center beam;
(b) a plurality of legs;
(c) a plurality of brackets, wherein each of the brackets comprise:
a top socket;
a mechanism for allowing the plurality of legs to pivot, wherein the mechanism orients the legs at an angle that causes the legs to bind when the legs are in a closed position; and
a plurality of leg sockets, wherein the leg sockets are connected to the top socket in an off-centered arrangement; and
(d) a mechanism for locking the plurality of legs.

2. The sawhorse of claim 1, wherein the center beam comprises a wood plank substantially sized 2 inches by 6 inches.

3. The sawhorse of claim 1, wherein the plurality of legs comprise four separate legs.

4. The sawhorse of claim 3, wherein each separate leg is a wood plank substantially sized 2 inches by 4 inches.

5. The sawhorse of claim 1, wherein each of the plurality of brackets comprise two leg sockets.

6. The sawhorse of claim 1, wherein the plurality of legs are oriented at an angle in the range of ten to twenty degrees from a vertical line extending parallel to the median plane of the top socket.

7. The sawhorse of claim 1, wherein the plurality of legs are oriented at an angle of substantially fifteen degrees from a vertical line extending parallel to the median plane of the top socket.

8. The sawhorse of claim 6, wherein the plurality of legs are oriented at an angle in the range of ten to twenty degrees from a vertical line extending parallel to the coronal plane of the top socket.

9. The sawhorse of claim 7, wherein the plurality of legs are oriented at an angel of substantially fifteen degrees from a vertical line extending parallel to the coronal plane of the top socket.

10. The sawhorse of claim 1, wherein the orientation of one of the brackets is generally opposite to the orientation of another of the brackets.

11. The sawhorse of claim 1, wherein the locking mechanism comprises a pin and clip.

12. The sawhorse of claim 1, wherein the locking mechanism comprises a solid plate and a screw, and wherein the plate is connected to the screw to allow the plate to rotate about the screw.

13. The sawhorse of claim 1, wherein the mechanism for allowing the plurality of legs to pivot allows the plurality of legs to pivot into, and out of, an open position.

14. The sawhorse of claim 1, wherein the mechanism for allowing the plurality of legs to pivot includes a respective bolt oriented at an angle greater or less than 90° with respect to a respective wall of each of the plurality of leg sockets.

15. The sawhorse of claim 1, wherein the top socket comprises a mechanism for connecting the lateral sides of the center beam to the top socket.

16. A sawhorse bracket comprising:
(a) a top socket;
(b) a plurality of leg sockets, wherein the leg sockets are connected to the top socket in an off-centered arrangement, wherein the leg sockets are constructed to accommodate sawhorse legs at an angle in the range of ten to twenty degrees from a vertical line extending along the median plane of the top socket, and wherein the leg sockets are constructed to accommodate sawhorse legs at an angle in the range of ten to twenty degrees from a vertical line extending along the coronal plane of the top socket; and
(c) a mechanism for allowing sawhorse legs connected to the leg sockets to pivot, wherein the mechanism orients the sawhorse legs at an angle that causes the sawhorse horse legs to bind when the sawhorse legs are in a closed position.

17. The sawhorse bracket of claim 16, further comprising a locking mechanism.

18. The sawhorse bracket of claim 16, further comprising a mechanism for allowing a plurality of legs connected to the bracket to pivot.

19. The sawhorse bracket of claim 16, wherein the leg sockets are constructed to hold sawhorse legs at an angle of substantially fifteen degrees from a vertical line extending parallel to the median plane of the top socket.

20. The sawhorse bracket of claim 19, wherein the leg sockets are constructed to accommodate sawhorse legs at an angle of substantially fifteen degrees from a vertical line extending parallel to the coronal plane of the top socket.
